(19) United States
(12) Patent Application Publication
(10) Pub. No.: US 2010/0098506 A1
(43) Pub. Date: Apr. 22, 2010

(54) CEMENTED CARBIDE, CUTTING TOOL, AND CUTTING DEVICE

(75) Inventors: Isamu TANAKA, Kagoshima (JP); Takeshi OHKUMA, Kagoshima (JP); Shintaro KUBO, Kagoshima (JP)

Correspondence Address: BIRCH STEWART KOLASCH & BIRCH, PO BOX 747, FALLS CHURCH, VA, 22040-0747, US

(73) Assignee: KYOCERA CORPORATION, Kyoto-shi (JP)

(21) Appl. No.: 12/645,432

(22) Filed: Dec. 22, 2009

Related U.S. Application Data
(63) Continuation-in-part of application No. PCT/JP2008/061736, filed on Jun. 27, 2008.

(30) Foreign Application Priority Data
Jun. 27, 2007 (JP) 2007-169699
Dec. 25, 2007 (JP) 2007-331735
May 27, 2008 (JP) 2008-137522

(51) Int. Cl. B23C 5/16; B22F 7/02; B23B 27/14

(52) U.S. Cl. 407/119; 428/548; 407/53; 408/199

(57) ABSTRACT

The invention relates to a cemented carbide material having a hard phase including tungsten carbide (WC) grains having an average grain size of 0.3 microns or less and also including cobalt (Co) as a bonding phase. The material also includes cobalt tungsten carbide grains that have a smaller average grain size than that of the tungsten carbide grains. The cemented carbide material has use, among others, in making cutting tools.

### TECHNICAL FIELD

The present invention relates to cemented carbides, cutting tools and cutting apparatuses, and particularly to a cutting tool, such as a small-diameter end mill, a small-diameter drill, and a small-diameter punch, particularly a miniature drill, and to a cutting apparatus.

### BACKGROUND ART

Tungsten carbide (WC)/cobalt (Co) cemented carbides are used as the material of cutting tools for cutting metals or working printed circuit boards because of their high wear resistance, high temperature strength and high elastic modulus. A cemented carbide is particularly widely used which contains mainly WC grains, carbides such as of titanium, niobium, zirconium, chromium, vanadium and tantalum, and cobalt as bonding phases.

The mechanical properties of the above-mentioned WC/Co cemented carbide are affected by the amount of Co phases acting as the bonding phases, the grain size of WC grains, and the distances between the WC grains. In general, as the WC grain size is reduced, the mechanical properties, particularly hardness and strength, are increased. For producing a WC/Co cemented carbide, accordingly, at least one of vanadium carbide (VC), chromium carbide (Cr₃C₂), tantalum carbide (TaC) and niobium carbide (NbC) is added as a grain growth inhibitor.

The carbon content in a WC/Co cemented carbide is a major factor determining the properties of the entire alloy, and accordingly the carbon content is strictly controlled in manufacture. In general, carbon is added in such an amount that each metallic element forms a carbide having a stoichiometric composition. If the carbon content is high, free carbon precipitates in the alloy. In contrast, if the carbon content is low, a cobalt tungsten carbide containing little carbon, such as Co₃W₃C, Co₆W₆C, Co₂W₄C or Co₃W₉C4 (hereinafter collectively referred to as η phase in some cases) precipitates in the alloy. In view of the properties of the alloy, so-called healthy alloys not containing free carbon or η phases are generally used. This is because it is considered that free carbon and η phases are liable to cause fracture and degrade the cutting properties of the cemented carbide.

A cemented carbide has been proposed whose wear resistance to materials difficult to cut, such as stainless steel, is enhanced by positively promoting the precipitation of Co₃W₃C (see, for example, Patent Document 1). Another cemented carbide has also been proposed whose wear resistance and defect resistance are enhanced by precipitating and dispersing a trace amount of 11 phase (see, for example, Patent Document 2).

Patent Documents 3, 4 and 5 disclose cemented carbide materials for miniature drills.

Patent Document 1: Japanese Examined Patent Application Publication No. 63-27421

Patent Document 2: Japanese Unexamined Patent Application Publication No. 6-65671

Patent Document 3: Japanese Unexamined Patent Application Publication No. 5-117799

Patent Document 4: Japanese Unexamined Patent Application Publication No. 2004-190118

Patent Document 5: Japanese Unexamined Patent Application Publication No. 2007-262475

### DISCLOSURE OF INVENTION

### Problems to be Solved by the Invention

However, the cemented carbide disclosed in Patent Document 1 contains a low-strength η phase in a higher proportion, and accordingly exhibits a lower strength disadvantageously.

The cemented carbide disclosed in Patent Document 2 undesirably has a 30% lower strength than healthy alloys. Although the cemented carbide of Patent Document 2 may contain a trace amount of η phase in some cases, the WC grains are large in grain size. Probably, this is the reason why the strength is low.

In addition, since the cemented carbides of Patent Documents 1 and 2 contain large WC grains, they cannot be used for miniature drills or the like for working printed circuit boards as they are.

Furthermore, miniature drills have been intensively developed in recent years, and increasingly miniaturized to a cutting edge diameter as small as 300 μm or less, or further 100 μm or less, as disclosed in Patent Documents 3 to 5. As the cutting edge of the miniature drill is reduced, the grain size of the WC grains in the cemented carbide for miniature drills is reduced to 0.5 μm or less, and further to 0.3 μm or less. Following the refinement of the WC grains, η phase grains larger than the WC grains appear. Accordingly, breakage easily occurs from a η phase grain having a low strength in the miniature drill.

An object of the present invention is to provide a cemented carbide, a cutting tool and a cutting apparatus having a high strength and high hardness and preventing breakage.

### Means for Solving the Problems

As a result of intensive research, the inventors of the present invention found that a cemented carbide having superior mechanical strength and high hardness and capable of preventing breakage can be produced by controlling the I₁/I₂ so as to satisfy the relationship 0<I₁/I₂≦0.05, controlling the average grain size of WC grains in a WC—Co cemented carbide to 0.3 μm or less, and dispersing and precipitating a trace amount of η phase grains having an average grain size smaller than the WC grains. The inventors have thus accomplished the invention.

According to the invention, a cemented carbide comprises WC grains as a hard phase, Co as a bonding phase, and grains of at least one cobalt tungsten carbide selected from the group consisting of Co₃W₃C, Co₆W₆C, Co₂W₄C, and Co₃W₉C. 0<I₁/I₂≦0.05 is satisfied, where I₁ represents the maximum peak intensity of Cukα X-ray diffraction peaks of the Co₃W₃C, the Co₆W₆C, the Co₂W₄C and the Co₃W₉C, and I₂ represents the maximum peak intensity of the WC. The WC grains have an average grain size of 0.3 μm or less, and the cobalt tungsten carbide grains have an average grain size smaller than the average grain size of the WC grains.

The number of cobalt tungsten carbide grains having a grain size of 1 μm or more is one or zero in a field of view of 40 μm square of an electron micrograph of a section of the cemented carbide taken at a magnification of 30000 times.

The one or more WC grains each contain a carbon grain therein, and the outer portion of the carbon grain has lattice planes continuing to the lattice planes of the WC grain.

The carbon grain has an average grain size of 50 nm or less.

The bonding phase contains 3% by mass or less of oxygen.

The WC grains comprise columnar grains, a plurality of tetragonal sections of the WC grains are exposed at an arbitrary section of the cemented carbide, and the tetragonal sections of the WC grains having an aspect ratio of 2 or more account for 10% or more of all the tetragonal sections of the WC grains on an area basis.

The tetragonal sections of the WC grains having an aspect ratio of 2 or more each have a long side and the average length of the long sides is 1 μm or less.

The tetragonal sections of the WC grains have an aspect ratio of 2 or more account for 30% or less of all the tetragonal sections of the WC grains on an area basis.

A cutting tool comprises the above-mentioned cemented carbide.

A cutting apparatus comprises the above-mentioned cutting tool and a support configured to support a material to be cut with the cutting tool.

### ADVANTAGES

In the cemented carbide of the present invention, the strength of the alloy can be enhanced mainly by controlling the average WC grain size to 0.3 μm or less, and the hardness of the bonding phases can be enhanced mainly by controlling the I₁/I₂ so as to satisfy the relationship 0<I₁/I₂≦0.05 and dispersing a trace amount of high-hardness η phase in the bonding phases. Thus, the wear resistance can be enhanced. In addition, by controlling the average grain size of the η phase to be smaller than the average grain size of the WC grains, the amount of η phase grains larger than the WC grains is reduced. Consequently, breakage occurring from such a low-strength, coarse η phase grain can be prevented.

By using such a cemented carbide for a cutting tool, the resulting cutting tool can have high strength and high hardness and prevent breakage, thus exhibiting enhanced cutting properties. In addition, the use of the cemented carbide can achieve a cutting tool having a long lifetime, for example, a miniature drill exhibiting superior performance in working printed circuit boards.

### BRIEF DESCRIPTION OF DRAWINGS

FIG. 1 is a SEM photograph of a cemented carbide according to an embodiment of the present invention.

FIG. 2 is an X-ray diffraction pattern of a cemented carbide according to an embodiment of the present invention.

FIG. 3(a-1) Is a side view of a small-diameter cemented carbide bar, (a-2) is a front view of the small-diameter cemented carbide bar, and (b) is a side view of a miniature drill.

FIG. 4(a) Is a schematic representation of a cemented carbide containing carbon grains in WC grains, and (b) is a fragmentary enlarged schematic representation of the cemented carbide.

FIG. 5 is a TEM photograph of a cemented carbide containing carbon grains in WC grains.

FIG. 6 is an SEM photograph of a cemented carbide containing tetragonal sections.

### BEST MODE FOR CARRYING OUT THE INVENTION

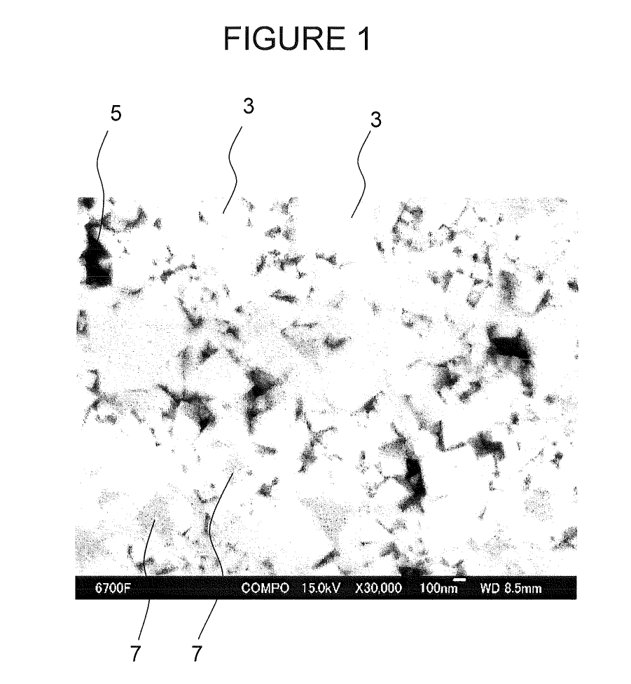

FIG. 1 shows a cemented carbide according to an embodiment, and the cemented carbide comprises hard phases 3 and bonding phases 5. The hard phase 3 comprises WC grains. The bonding phase 5 is mainly composed of Co, and the Co content is 5% to 15% by mass in the entirety of the cemented carbide. The WC content in the entire alloy is 81% to 95% by mass.

Preferably, the cemented carbide contains 0.1% to 1.5% by mass of vanadium in terms of carbide (VC) and 0.1% to 2.5% by mass of chromium in terms of carbide (Cr₃C₂), from the viewpoint of enhancing the strength of the bonding phases 5.

The vanadium (V) and the chromium (Cr) act as an intermediate at the interface between the WC and the Co to enhance the adhesion between the WC and the Co. The vanadium and the chromium also act as grain growth inhibitors of the WC and the Co. These grain growth inhibitors are dissolved in the Co in the bonding phases 5. Part of the vanadium (V) is present in the WC.

FIG. 1 is a photograph of the section of a cemented carbide taken through a scanning electron microscope (SEM) at a magnification of 30000 times. The WC grains of the hard phase has an average grain size of 0.3 μm or less, and preferably 0.2 μm or less particularly from the viewpoint of enhancing the strength. In order to mix raw material powders, the average grain size of the WC grains is preferably 0.1 μm or more. The WC grain has a triangle pole shape, and looks like triangle or tetragon depending on the viewing angle. For calculating the average grain size of such WC grains, the total area of the WC grains in a scanning electron micrographic (SEM) photograph is measured, and the total area is divided by the number of the WC grains. The resulting average area is converted to the diameter of a sphere, assuming that the WC grain is spherical. The area of the WC grains can be measured by, for example, image software (ImagePro Plus produced by Nippon Roper).

A major feature of the cemented carbide of the present embodiment is that q phases 7 are present in addition to the hard phases 3 and the bonding phases 5, as shown in FIG. 1. The η phases 7 are shown in dark regions in FIG. 1. The η phase 7 comprises cobalt tungstens, such as C₃W₃C, Co₆W₆C, Co₂W₄C, and Co₃W₉C. The η phase 7 may contain V or Cr dissolved in the C₃W₃C, Co₆W₆C, Co₂W₄C or Co₃W₉C. In the X-ray (CuKα-ray) diffraction pattern of the η phase 7, the maximum peak includes a synthetic peak of (333) and (511) of Co₃W₃C, a synthetic peak of (333) and (511) of Co₆W₆C, a synthetic peak of (333) and (511) of Co₂W₄C, and a peak of (301) of Co₃W₉C.

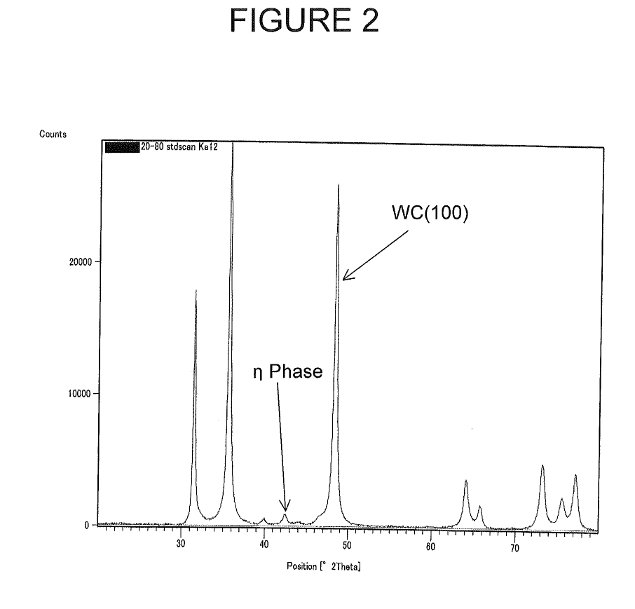

In the present invention, the peak intensity ratio expressed by I₁/I₂ is more than 0 and 0.05 or less, wherein represents the height of the peak having the highest intensity of the peaks of the η phase 7, and I₂ represents the peak height of (001) of WC, which is the maximum peak of the peaks of WC. FIG. 2 shows an X-ray diffraction pattern. In FIG. 2, the η phase has peaks around 2θ=40° and 42.5°, and the I₁/I₂ in this case is 0.03. The peak around 40° shown in FIG. 2 is the peak of (422) of C₃W₃C. The peak intensity is represented by the count value of X-ray diffraction analysis.

By setting the peak intensity ratio I₁/I₂ to 0<I₁/I₂≦0.05 so that a trace amount of η phase is present in the alloy, the hardness of the bonding phase can be enhanced. If the peak intensity ratio is 0, however, the phase does not precipitate in the alloy. Accordingly, the hardness of the alloy, which is enhanced by enhancing the hardness of the bonding phase, cannot be enhanced. Consequently, the wear resistance of the tool is reduced to increase the degree of wear. In addition, since the adhesion between the hard phase and the bonding phase is reduced, the bending strength is reduced. In contrast, if I₁/I₂ is increased over 0.05, an excessive amount of η phase precipitates to reduce the bending strength. Preferably, I₁/I₂ is in the range of 0.005 to 0.03, more preferably 0.005 to 0.02, from the viewpoint of enhancing the bending strength.

In Cukα X-ray diffraction, the synthetic peak of (333) and (511) of Co₃W₃C lies around 2θ=42.5°; the synthetic peak of (333) and (511) of Co₆W₆ lies around 2θ=43°; the synthetic peak of (333) and (511) of Co₂W₄C lies around 2θ=42°; and the peak of (301) of Co₃W₉C lies around 2θ=41°.

The η phase 7 has an average grain size smaller than the average grain size of the WC grains; hence, the average grain size of the η phase is less than 0.3 μm. In particular, it is preferable that the average grain size of the η phase be 0.2 μm or less from the viewpoint of preventing breakage. The average grain size of the η phase can be obtained in the same manner as the average grain size of the WC grains.

By controlling I₁/I₂ so as to satisfy the relationship 0<I₁/I₂≦0.05, by reducing the average grain size of the WC grains to 0.3 μm or less, and by dispersing a trace amount of η phase having an average grain size smaller than the average grain size of the WC grains, the strength and hardness of the cemented carbide can be enhanced to prevent breakage.

More specifically, the strength of the alloy can be enhanced mainly by controlling the average WC grain size to 0.3 μm or less, and the hardness of the bonding phase can be enhanced mainly by controlling the I₁/I₂ so as to satisfy the relationship 0<I₁/I₂≦0.05 and dispersing a trace amount of high-hardness η phase in the bonding phase. Thus, the wear resistance can be enhanced. In addition, by controlling the average grain size of the η phase to be smaller than the average grain size of the WC grains, the amount of η phase grains larger than the WC grains is reduced. Consequently, breakage occurring from such a low-strength, coarse grain of the η phase can be prevented.

In the present embodiment, preferably, the number of cobalt tungsten carbide grains (η phase grains) having a grain size of 1 μm or more is one or zero in a field of view of 40 μm square of a scanning electron micrograph of a section of a sintered compact taken at a magnification of 30000 times. It is particularly preferable that such a grain be not present. Such a cemented carbide can prevent a breakage occurring from a large η phase grain. In addition, the η phase grains can be prevented from disappearing, and thus breakage can be reduced. For counting the number of cobalt tungsten carbide grains (η phase grains) having grain sizes of 1 μm or more, η phase grains whose maximum width is 1 μm or more are counted in a scanning electron micrograph.

In manufacture of the cemented carbide of the present embodiment, WC fine powder and Co powder are used as the raw material. In addition, a grain growth inhibitor, such as VC powder and Cr₃C₂ powder, and a carbon content adjustor, such as carbon black (C), are added to the raw material. The grain growth inhibitor may be either VC powder or Cr₃C₂ powder. In order to refine the WC and in order to disperse the Co uniformly, preferably, the WC powder and the Co powder are added in a form of WC—Co complex carbide powder that is prepared by dissolving water-soluble salts of W and Co in water, drying the solution, heat-treating the dried material, and carbonizing the material.

Preferably, the VC powder and the Cr₃C₂ powder have average particle sizes of 1.0 μm or less, and each contains 0.5% by mass or less of oxygen. Preferably, the WC powder has an average particle size of 0.25 μm or less and contains 0.2% by mass or less of oxygen. In order to reduce the oxygen content in the WC powder, the VC powder and the Cr₃C₂ powder, those powders can be carbonized in a strengthened carbonizing atmosphere. The oxygen content can be measured by infrared absorption spectrometry.

As alternatives to VC power and Cr₃C₂ powder, tantalum carbide (TaC) and/or niobium carbide (NbC) may be used as the grain growth inhibitor. In this instance, it is also preferable that their average particle sizes be 1.0 μm or less, and that their oxygen contents be 0.5% by mass or less.

The above powders are weighed out and mixed and pulverized with an organic solvent, such as acetone or propanol, in a wet process. After being dried, the mixture is formed by a known method, such as press forming, then fired, and further subjected to hot isostatic pressing (HIP) firing with a pressure applied. The organic solvent is preferably acetone or propanol, which contains little oxygen. Preferably, the number of cycles of wet mixing and pulverization with an organic solvent is minimized to minimize the time for which the material is immersed in the organic solvent. The firing is performed in a firing furnace evacuated to a vacuum of 0.133 to 13.3 Pa (10⁻¹ to 10⁻³ Torr) at a temperature in the range of 1300 to 1390° C. for 10 minutes to 2 hours, and further performed at a temperature of 1290 to 1380° C. in an Ar atmosphere in the firing furnace whose inner pressure is increased to 1 to 10 MPa.

If a powder prepared by dissolving water-soluble salts of W and Co in water, drying the solution, heat-treating the dried material, and then carbonizing the material is used as the WC—Co complex carbide powder, VC powder and Cr₃C₂ powder are added immediately before firing as much as possible. If an organic solvent is added for mixing and pulverized, the organic solvent is selected from solvents containing little OH group, and the mixing and pulverizing time is reduced. In addition, the number of additions of organic solvent to VC and Cr₃C₂ is reduced as much as possible. Thus, the oxygen content can be reduced.

Since the oxygen contents in the VC powder, the Cr₃C₂ powder and the WC powder are reduced, and a solvent containing little OH group is selected for wet mixing and pulverization, the oxygen content before firing is reduce. Consequently, the amount of η phase can be controlled by varying the amount of carbon black (C) to be added.

If the oxygen contents in the VC powder and the Cr₃C₂ powder are higher than 0.5% by mass, coarse η phase grains are easily precipitated by firing. This is probably because VC and Cr₃C₂ are more easily oxidized than WC, and, accordingly, their surfaces are oxidized by reacting with the off group during firing. Then, the oxygen at the surface of the VC or Cr₃C₂ powder is removed by reaction with surrounding carbon or the C of the WC to produce CO. Consequently, the surrounding carbon content is excessively reduced to form a large η phase.

If the particle sizes of the VC powder and Cr₃O₂ powder are increased, coarse η phase grains are easily produced as well. On the other hand, if the WC grains are set to 0.3 μm or less, the particle size of the raw material is about 0.25 μm or less. Accordingly, the particle size of the grain growth inhibitor, such as VC powder and Cr₃C₂ powder, is reduced to enhance the dispersibility. However, the surface area of the grain growth inhibitor is increased, and accordingly the amount of oxygen adsorbed is increased, and may further be increased if the grain growth inhibitor aggregates. In particular, when the WC grains are refined, coarse η phase grains are precipitated. Thus, the average grain size of the η phase grains becomes larger than the average grain size of the WC grains.

More specifically, when the WC grains are as large as 0.5 μm or more, the η phase grains hardly become larger than the WC grains even if the η phase grains are present. Accordingly, the properties of, for example, a miniature drill, are not affected. However, as the diameter of the miniature drill is reduced and the WC grains is reduced to 0.3 μm or less, η phase grains having a grain size larger than WC grains become present. Thus, the miniature drill is easily broken from a point of η phase grains having lower strength than WC.

In this state, many η phase grains having a grain size of 1 μm or more become present in a field of view of 40 μm square of a scanning electron micrograph of the section of a cemented carbide taken at a magnification of 30000 times. Consequently, breakage easily occurs from a low-strength η phase grain.

In the present embodiment, even if the WC powder is micronized and the grain growth inhibitor, such as VC power and Cr₃C₂ powder, is micronized, the η phase can certainly controlled to an amount in which the relationship 0<I₁/I₂≦0.05 holds, by reducing the oxygen content in the raw materials, reducing the number of cycles and the time of wet mixing and pulverizations, using a solvent containing little oxygen, and controlling the amount of the carbon source, such as carbon black (C). In addition, the average grain size of WC can be reduced to 0.3 μm or less, and the average grain size of η phase grains can be reduced to a size smaller than the average grain size of WC. Furthermore, the number of η phase grains having grain size of 1 μm or more can be one or zero in a field of view of 40 μm square of a scanning electron micrograph of the section of a cemented carbide taken at a magnification of 30000 times.

A cutting tool according to an embodiment of the invention is made of the above-described cemented carbide. Examples of the cutting tools include cutting tools requiring high hardness, high strength and breakage resistance, such as small-diameter mills, small-diameter drills (including miniature drills) and small-diameter punches. The cemented carbide can be used particularly suitably for miniature drills. When the diameter of the cutting edge is 300 μm or less, particularly 200 μm or less, more particularly 100 μm or less, breakage occurs easily. The cemented carbide of the present invention can be suitably used for such cases. Furthermore, the present invention can be suitably used for a thin bar-like portion (having a diameter of 300 μm or less) of the cutting tool. For example, when the cutting edge of a miniature drill has a length of 1 mm or more, the present invention can be suitably applied.

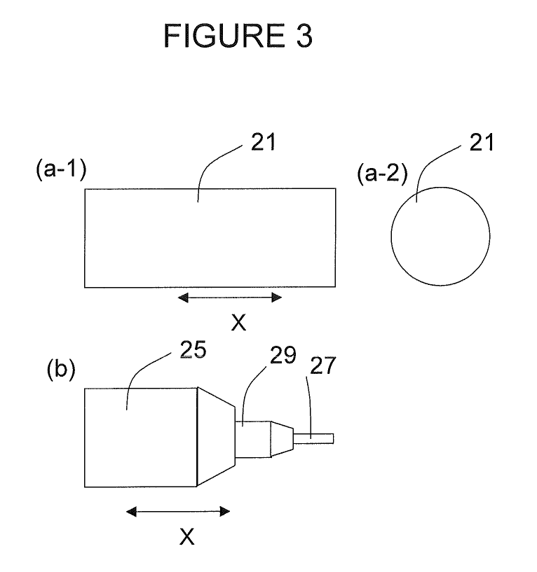

A miniature drill is a type of very small drills, and is suitable to form a hole in a substrate, particularly a printed circuit board, but not limited to such use. A miniature drill refers particularly to a drill including a cutting edge having a diameter of 300 μm or less. For manufacturing such a miniature drill, in general, a cutting edge is formed by cutting one end in the longitudinal direction X of a small-diameter cemented carbide bar 21 having a circular section, as shown in FIGS. 3(a-1) and 3(a-2), and forming a spiral groove in the bar. Also, as shown in FIG. 3(b), a cylindrical shank portion 25 and the cutting edge 27 having a circular section are integrated in the longitudinal direction X with a stepped portion 29 therebetween. The shank portion 25 has a length of 10 to 30 mm, and the cutting edge 27 has a length of 1 to 3 mm. The stepped portion 29 is not always necessary. FIG. 3(a-1) is a side view of the small-diameter cemented carbide bar 21, and FIG. 3(a-2) is a front view of FIG. 3(a-1).

A cutting apparatus can include the cutting tool and a support for supporting a material to be cut with the cutting tool. Exemplary cutting apparatuses include turning apparatuses including the cutting tool, such as lathes, and milling apparatus including the cutting tool, such as machining centers. Such a cutting apparatus can perform cutting over the long term without replacing the cutting tool. Thus, the number of replacements of the cutting tool can be reduced, and accordingly, cost can be reduced.

The cutting apparatus using a miniature drill includes the miniature drill, a holder holding the shank portion of the miniature drill, and a fixing portion fixing, for example, a substrate.

In the present embodiment, it is preferable that WC grains contain carbon grains, and that the lattice planes of the outer portion of the carbon grain continue to the lattice planes of the WC grain.

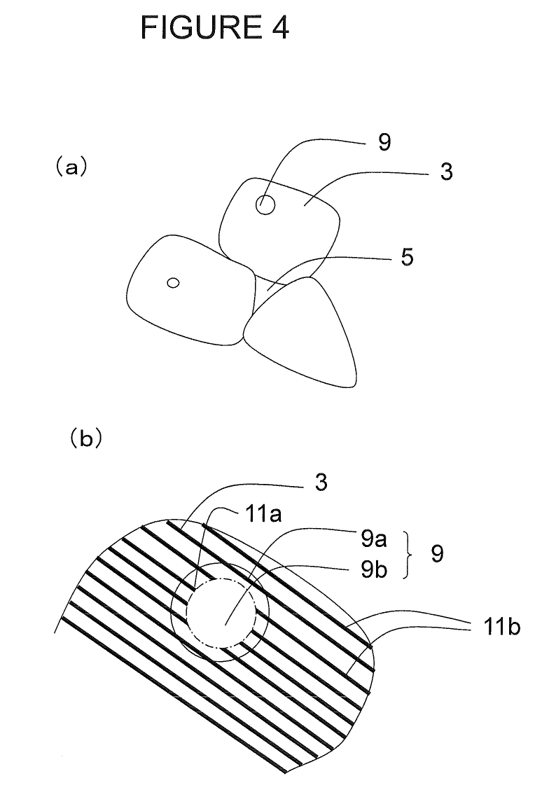

More specifically, a carbon grain 9 is present in a WC grain being the hard phase 3, and the lattice planes 11a of the outer portion 9a of the carbon grain 9 continue linearly to the lattice planes 11b of the WC grain, as shown in FIGS. 4(a) and 4(b). In other words, the outer portion 9a of the carbon grain 9 has the same crystal structure as the WC grain. Probably, the outer portion 9a of the carbon grain 9 is drawn by crystallization of the WC, so that the lattice planes 11a of the outer portion 9a of the carbon grain 9 is continued to the lattice planes 11b of the WC grain. Thus, the outer portion 9a of the carbon grain 9 can be the portion having lattice planes 11a continuing the lattice planes 11b of the WC grain. On the other hand, the middle portion 9b of the carbon grain 9 is considered to be amorphous.

Since the outer portion 9a of the carbon grain 9 has a structure close to diamond and has a high hardness, the hardness of the cemented carbide can be enhanced. Accordingly, a cutting tool, such as a miniature drill, using the cemented carbide of the present embodiment can perform cutting continuously even if the WC grains are gradually worn, because the outer portions 9a of the hard carbon grains 9 in the WC grains cut a material. Thus, the lifetime can be increased.

Preferably, the carbon grains 9 have an average grain size of 50 nm or less. The average grain size of the carbon grains 9 can be obtained by averaging the maximum width of each carbon grain 9 measured using a photograph of a section.

For forming carbon grains 9, it is preferable to hold a temperature of 900 to 1100° C. for a certain time during firing, as described below. The presence of such fine carbon grains 9 allows the increase of the percentage of the portion having lattice planes continuing to the lattice planes of the WC grain (the percentage of the outer portion 9a) in the carbon grain 9, and the hardness can further be enhanced. In order to produce finer carbon grains 9, the temperature to be held during firing is reduced.

If the average grain size of the carbon grain 9 is larger than 50 nm, the percentage of the portion having lattice planes continuing to the lattice planes of the WC grain (percentage of the outer portion of the carbon grain) is reduced, and the effect of enhancing the hardness is small. Preferably, the average grain size of the carbon grain 9 is 40 nm or less, more preferably 35 nm or less, from the viewpoint of enhancing the hardness. In addition, from the viewpoint of preventing the carbon grain 9 from disappearing, the average grain size is preferably 10 nm or more, and more preferably 15 nm or more.

Probably, one WC grain contains at least one carbon grain 9. Since an arbitrary section of the cemented carbide is observed, the carbon grain 9 may not be observed in some WC grains in practice. It is however believed that the carbon grain can be observed by observing another section.

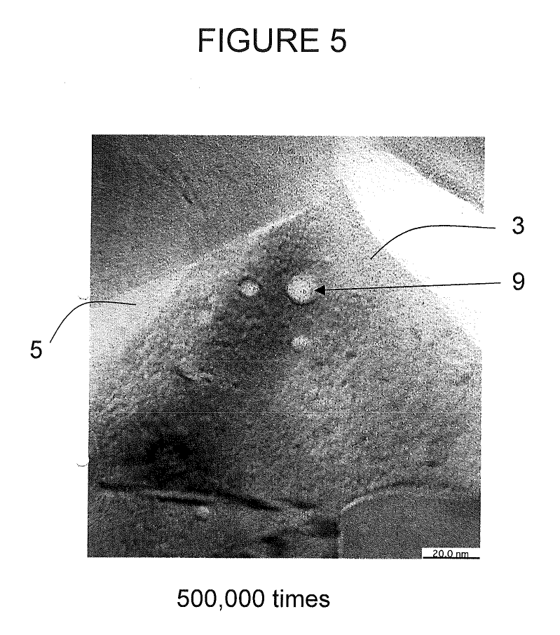

FIG. 5 is a photograph of a section of the cemented carbide according to the present embodiment taken through a transmission electron microscopic (TEM) at a magnification of 500 thousand times. This photograph only shows a carbon grain 9. A photograph taken at a magnification of a million times, however, can show lattice fringes (lattice planes) in a WC grain being the hard phase 3, and shows that the lattice fringes (lattice planed 11b) extend linearly to the outer portion 9a of the carbon grain 9, and that the lattice planes 11a of the outer portion 9a of the carbon grain 9 continue linearly to the lattice planes 11b of the WC grain, as shown in FIG. 4(b). If the bonding phase is measured by an energy dispersive spectrometer (EDS), trace additives are detected, such as Co, W, C, O, V and Cr.

In the cemented carbide according to the present embodiment, the lattice planes of the outer portion of the carbon grain continue linearly to the lattice planes of the WC grain. In other words, the WC grain in the cemented carbide contains a carbon grain whose outer portion has the same crystal structure as the WC grain. Accordingly, the outer portion of the carbon grain has characteristics just like diamond, and can enhance the hardness. Preferably, such a cemented carbide contains 0.01% to 0.5% by mass of vanadium carbide therein.

If the carbon grain of the cemented carbide according to the present embodiment has an average grain size of 50 nm or less, the percentage of the outer portion of the carbon grain having lattice planes continuing the lattice planes of the WC grain is increased, and thus the hardness can be further enhanced.

Preferably, the oxygen content in the bonding phase of the cemented carbide of the present embodiment is 3% by mass or less. Since the oxygen content in the bonding phase is 3% by mass or less in such as cemented carbide, the bonding phase can enhance the adhesion between the WC grains, and thus the mechanical strength of the cemented carbide can be enhanced.

A method for producing the cemented carbide shown in FIG. 5 in which WC grains contain carbon grains 9 will now be described.

For producing the cemented carbide of the present embodiment, the oxygen content in each raw material is controlled as described above. Also, water-soluble salts of W, Co, V and Cr are dissolved in water, and the solution is dried to yield a powder in order to refine the WC and to disperse Co being the bonding phase and V and Cr being the grain growth inhibitor uniformly. The resulting powder is thermally decomposed at 450 to 600° C. in an atmosphere of, for example, nitrogen, Ar or vacuum, and subsequently carbonized at a temperature of 700 to 1000° C. in an atmosphere of, for example, CO/H₂ or an atmosphere containing methane or ethane. Thus prepared WC—Co complex carbide powder (containing V and Cr) is used. Cr₃C₂ may be added as Cr after carbonization, instead of adding a water-soluble salt of Cr. The V and Cr are dissolved in the WC and in the Co of the WC—Co complex powder, and are also present in a form of oxides and/or carbides of V and Cr.

The addition of Cr can enhance the resistance to oxidation during cutting with the cutting tool, and can prevent the reduction of strength resulting from oxidation of the material. In this instance, Co is uniformly dispersed as 10 to 50 nm grains on the surface of the WC grain.

The WC—Co complex carbide powder and a slurry containing carbon for controlling the C content are weighed out and mixed and pulverized with an organic solvent, such as acetone or propanol, in a wet process. After being dried, the mixture is formed by a known method, such as press forming, then fired, and further subjected to hot isostatic pressing (HIP) firing with a pressure applied. At this time, in order to reduce the oxygen content before firing, the oxygen content in the WC—Co complex carbide powder is reduced, and an organic solvent containing little OH group is used for the wet mixing.

The firing is performed in a firing furnace evacuated to a vacuum of 0.133 to 13.3 Pa (10⁻¹ to 10⁻³ Torr) at a temperature of 900 to 1100° C. held for 0.5 to 5 hours and then at a temperature of 1300 to 1390° C. for 10 minutes to 2 hours. Subsequently, the inner pressure of the firing furnace is increased to 1 to 10 MPa in an Ar atmosphere, and HIP firing is performed at a temperature of 1290 to 1380° C. for 10 minutes to 2 hours. Consequently, the relationship 0<I₁/I₂≦0.05 holds, the average grain size of the WC grains becomes 0.3 μm or less, and the average grain size of the cobalt tungsten carbide grains becomes smaller than that of the WC grains.

In this instance, by performing firing in a state where a temperature of 900 to 1100° C. is held for a certain time, the reaction of oxygen and water adsorbed on the WC surfaces to react with the carbon in the WC can be promoted, and thus the oxygen and water are removed as CO, before Co turns into a liquid phase (1200° C.). Thus, the oxygen content in the bonding phase can be reduced. V an Cr easily leach from the WC and dissolve in the Co under the condition where a temperature of 900 to 1100° C. is held for a certain time, and the WC starts crystallizing at temperatures of 900 to 1100° C. Consequently, the carbon in the WC is probably aggregated to portions from which V and Cr have been removed. Probably, the outer portion of the aggregated carbon is crystallized by firing, being drawn by the lattice planes of the WC. Thus, the outer portion of the carbon grain has lattice planes continuing to the lattice planes of the WC grain.

By adding V and Cr being the grain growth inhibitor as a solution when the WC—Co complex powder is synthesized, VC and Cr₃C₂ can be dispersed finely and uniformly. Consequently, V and Cr can rapidly be dissolved in the WC, the Co, or the like. Thus, the WC grains can be prevented from growing, effectively. Accordingly, the occurrence of coarse grains can be prevented, and thus a fine texture can be formed.

In the present embodiment, it is preferable that the WC grain have a columnar shape, that a plurality of tetragonal sections of WC grains be exposed at an arbitrary section of the cemented carbide, and that the tetragonal sections of the WC grains having an aspect ratio of 2 or more account for 10% or more of the total area of the tetragonal sections of the WC grains.

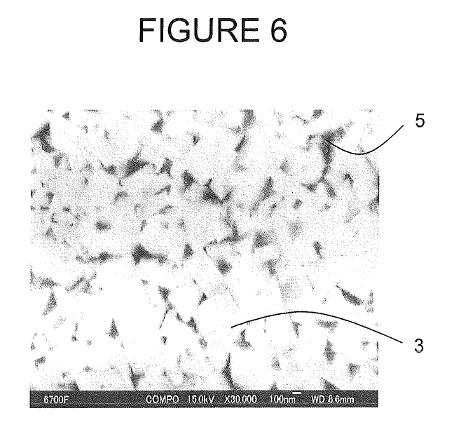

FIG. 6 is a photograph of an arbitrary section of the cemented carbide of the present embodiment taken through a scanning electron microscope (SEM) at a magnification of 30000 times. At the section of the cemented carbide shown in FIG. 6, a plurality of tetragonal sections of the WC grains are exposed. Whether or not the WC grain is columnar can be checked by micro-machining crystal grains of a sintered compact with a focused ion beam (FIB) apparatus, and repeatedly observing the shape of each micro-machined crystal grain in the depth direction using the scanning electron microscopic image.

The WC grains have a triangle pole shape with a triangular bottom and tetragonal sides, and the height of the triangle pole is larger than the sides of the triangular bottom. The aspect ratio mentioned herein is defined by dividing a long side (length) by a short side (width) of the tetragonal section of the WC grain exposed at an arbitrary section of the cemented carbide. The tetragonal section of the WC grain has two long sides and two short sides, and the aspect ratio is calculated from the longer long side and the longer short side.

In the cemented carbide of the present embodiment, it is preferable that the WC grain have a columnar shape as shown in FIG. 6, that a plurality of tetragonal sections of WC grains be exposed at an arbitrary section of the cemented carbide, and that the tetragonal sections of the WC grains having an aspect ratio of 2 or more account for 10% or more of the total area of the tetragonal sections of the WC grains. By controlling the area ratio of the sections having an aspect ratio of 2 or more to 10% or more in an arbitrary section of the cemented carbide, as above, the columnar grains are three-dimensionally intertwined with each other. Consequently, the columnar grains prevent a crack from growing (extending) when a load is applied, and, thus, the fracture toughness can be enhanced.

In an arbitrary section of the cemented carbide of the present embodiment, the sections of the WC grains having an aspect ratio of 1 to 2 account for less than 90% on a area basis.

In the present embodiment, the average length of the long sides of the tetragonal sections having an aspect ratio of 2 or more of the WC grains is preferably 1 μm or less. Since the average length of long sides of the sections having an aspect ratio of 2 or more is 1 μm or less, coarse grains, which can be a cause of fracture, are reduced to enhance the bending strength. Particularly preferably, the average length of the sections having an aspect ratio of 2 or more exposed at an arbitrary section of the cemented carbide is 0.7 μm or less. The tetragonal section of the WC grain has long sides and short sides, as mentioned above, and the average length of long sides refers to the average of the lengths of longer long sides.

In the present embodiment, the area ratio of the tetragonal sections having an aspect ratio of 2 or more to the tetragonal sections of the WC grains is preferably 30% or less. Since in such a cemented carbide, the area ratio of the sections having an aspect ratio of 2 or more is 30% or less, the intervals of columnar grains having larger aspect ratios, which interfere with the formation of a dense sintered compact, are filled with grains having smaller aspect ratios. The bending strength can thus be enhanced. Preferably, the area ratio of section having an aspect ratio of 2 or more is 14% to 25% from the viewpoint of enhancing the strength and the toughness. The area of the section having an aspect ratio of 2 or more is obtained by multiplying the longer long side by the longer short side.

The cemented carbide shown in FIG. 6 can be produced as below. First, in order to refine the WC grains, and in order to disperse Co being the bonding phase and V being the grain growth inhibitor uniformly, water-soluble salts of W, Co and V are dissolved in water and the solution is dried. The resulting powder is subjected to heat treatment (may be called thermal decomposition) for desalting, and, thus, a complex oxide powder is prepared. The resulting powder is carbonized, and the resulting complex carbide is used.

The V, which has been added in a small amount as the grain growth inhibitor, is turned into an oxide or a carbide and uniformly attached to the WC by the heat treatment. The oxide of V reacts with the surrounding carbon to form VC in the firing step described below. The V is also dissolved in the WC.

Predetermined amounts of the complex carbide powder, a slurry containing carbon for controlling the C content and Cr₃C₂ powder are weighed out and mixed. The mixture is pulverized with an organic solvent, such as acetone or propanol, in a wet process. After being dried, the mixture is formed by a known method, such as press forming, then fired, and further pressed and fired (for HIP). At this time, in order to reduce the oxygen content before firing, the oxygen content in the WC—Co complex powder is reduced, and an organic solvent containing little OH group is used for the wet mixing.

The firing is performed in a firing furnace evacuated to a vacuum of 0.133 to 13.3 Pa at a temperature in the range of 1300 to 1390° C. for 10 minutes to 2 hours, and subsequently (HIP) firing is performed at a temperature of 1290 to 1380° C. in an Ar atmosphere in the firing furnace whose inner pressure is increased to 1 to 10 MPa. Consequently, the relationship 0<I₁/I₂≦0.05 holds, the average grain size of the WC grains becomes 0.3 μm or less, and the average grain size of the cobalt tungsten carbide grains becomes smaller than that of the WC grains.

Particularly in the present invention, the V being the grain growth inhibitor is uniformly dispersed mainly by spray-drying a solution prepared by dissolving water-soluble salts of W, Co and V in water, and the oxide of V around the WC powder is melted to cover the surrounding of the WC by holding a temperature of 920 to 970° C., at which V₂O₅ melts, for a predetermined time during firing performed in an atmosphere of vacuum. Thus, the WC grains can be grown in the longitudinal direction. In other words, the growth in the longitudinal direction of the WC grains can be controlled by varying the time for which a temperature of 920 to 970° C. is held. If the holding time is short under the condition where the same temperature is held, the dissolved oxide of V cannot sufficiently be dispersed, and thus, a sufficient effect cannot be produced in growing columnar grains. If the holding time is excessively long, grains grow to coarse grains. Therefore, the holding time is preferably 1 to 2 hours.

In addition, by subsequent firing at an increased temperature, Cr is dissolved in the bonding phases to cover the WC grains, and thus, the growth (including the growth in the longitudinal direction) of the WC grains can be prevented.

By adding V and Cr being the grain growth inhibitor as a solution when the complex oxide powder is synthesized, V can be dispersed finely and uniformly. Consequently, V can rapidly be dissolved in the WC, the Co, or the like. Thus, grains can be prevented from growing, effectively. Accordingly, the occurrence of coarse grains can be prevented to produce a fine texture.

If V is added to the complex oxide powder and Cr is added to the complex carbide powder (during wet mixing), grains can be prevented from growing in a specific direction by holding a temperature of 920 to 970° C. for a predetermined time during firing. Consequently, columnar grains can be formed. The reason is not clear, but is probably that since V prevents grain growth particularly in a specific direction, the V finely and uniformly dispersed by spray-drying is easily dissolved in Co faster than in Cr by holding a temperature of 920 to 970° C. for a predetermined time during firing. The WC grains thus grow in a specific direction to form columnar grains before Cr exhibits the effect of preventing grain growth. The Cr then produces the effect of preventing grain growth to prevent the grain growth as a whole. Thus, the mechanical strength and the fracture toughness are enhanced.

On the other hand, if Cr is added together with V as an aqueous solution when the complex oxide powder is synthesized, the Cr is finely and uniformly dispersed as well as the V. Accordingly, the Cr is dissolved in Co to the same extent as V, and thus produces the effect of preventing grain growth as well. Consequently, columnar grains cannot be easily formed. If both V and Cr are added to a complex carbide powder, columnar grains cannot be easily formed because of the same reason.

The present invention will further be described below with reference to examples.

### Example 1

A water-soluble tungsten raw material (ammonium tungstate) and cobalt raw material (cobalt nitrate) were dissolved in water in a proportion of 100 g of mixed raw material to 500 mL of water, and the solution was dried by spray-drying. Then, 100 g of the resulting spray-dried powder was thermally decomposed at 500° C. in a nitrogen atmosphere to yield WO₃—CoO complex oxide powder. The complex oxide powder was carbonized at a temperature of 700 to 900° C. in a CO/H₂ atmosphere to yield WC—Co complex carbide powder (WC: 92% by mass, Co: 8% by mass). The WC—Co complex carbide powder has a structure in which Co is attached around the WC powder. The average grain size of the WC was measured by analyzing an SEM image. The result is shown in Table 1-1.

Mixed were 100 parts by mass of WC—Co complex carbide, 0.3 parts by mass of VC powder having an average particle size of 0.5 μm, and 0.6 parts by mass of Cr₃C₂ powder having an average particle size of 1 μm. In order to control the carbon content in the sintered compact, a trace amount of carbon slurry was further added so that the total carbon content in the mixed powder would be the value shown in Table 1-1. Then, the organic solvent shown in Table 1-1 was added, and wet mixing was performed for 72 hours in a ball mill. VC and Cr₃C₂ were each carbonized to prepare several types of raw material containing different amounts of oxygen.

After addition of a paraffin wax, the raw material slurry mixed in the ball mill was granulated and dried by spray-drying. After press forming, the material was fired in a vacuum, and subjected to hot isostatic pressing (HIP) to yield a cemented carbide. The heating rate before vacuum firing was 5° C./min, and the vacuum firing was performed at a temperature of 1350° C. for 1 hour. The hot isostatic pressing was performed under the conditions of a temperature of 1340° C. and a pressure of 6 MPa in argon gas.

After polishing the surface of the resulting cemented carbide, the cemented carbide was subjected to X-ray diffraction using Cukα ray, and the intensity ratio of the peak height I₁ of the η phase to the peak height I₂ of (001) of WC (shown around 2θ=48°) was calculated. Also, the grain size of the WC in the cemented carbide and the average grain size of the η phase were evaluated from a photograph taken through a scanning electron microscope (SEM) at a magnification of 30000 times. The evaluation was performed by image analysis software (ImagePro Plus produced by Nippon Roper). In addition, the Vickers hardness was evaluated under the condition of a load of 9.8 N, and the bending strength was evaluated by bending the sample at three points at intervals of 20 mm. The sample was formed into a columnar shape having a diameter of 2 mm and a length of 30 mm.

The number of η phase grains having a grain size of 1 μm or more in a field of view of 40 μm square was calculated from an electro micrograph of an arbitrary section of the cemented carbide taken at a magnification of 30000 times.

Furthermore, the wear resistance and the breakage resistance were evaluated under the following conditions by working the tip of each sample to form a drill having a diameter of 0.120 mm and a length of 2.0 mm. For the wear resistance, the hole position accuracy was used as the index for the evaluation. For the hole position accuracy, X+3σ of the formation of 4000 holes was used as the index, and the feed speed in the thickness direction was set at 3 m/min. For the breakage resistance, the maximum feed speed was used as the index for the evaluation. The maximum feed speed refers to the maximum of feed speeds at which the drill is broken when the feed speed in the thickness direction is gradually increased for each hole. The results are shown in Table 1-2. The working conditions were as follows:

Rotational speed of the drill: 300 krpm

Feed speed: 2 to 20 m/min

Substrate used for evaluation: multilayer substrate including a stack of Hitachi 679G (0.4 mm, three sheets) having an entry sheet (LE800, 1 sheet) thereon.

TABLE 1-1

| | Raw | | | | | |
|---|---|---|---|---|---|---|
| | material | | | | | |
| | particle | Oxygen | | | | C content |
| | size | content in raw | | | Solvent | Total carbon |
| Sample | (μm) | material (mass %) | | | Solvent used | content |
| No. | WC | WC | VC | Cr₃O₂ | for wet mixing | (mass %) |
| 1-1 | 0.1 | 0.15 | 0.4 | 0.45 | Acetone | 5.60 |
| 1-2 | 0.15 | 0.15 | 0.4 | 0.45 | Acetone | 5.60 |
| 1-3 | 0.2 | 0.15 | 0.4 | 0.45 | Acetone | 5.60 |
| 1-4 | 0.25 | 0.15 | 0.4 | 0.45 | Acetone | 5.60 |
| *1-5 | 0.5 | 0.15 | 0.4 | 0.45 | Acetone | 5.60 |
| *1-6 | 0.15 | 0.15 | 0.4 | 0.45 | Acetone | 5.50 |
| 1-7 | 0.15 | 0.15 | 0.4 | 0.45 | Acetone | 5.54 |
| 1-8 | 0.15 | 0.15 | 0.4 | 0.45 | Acetone | 5.56 |
| 1-9 | 0.15 | 0.15 | 0.4 | 0.45 | Acetone | 5.58 |
| 1-10 | 0.15 | 0.15 | 0.4 | 0.45 | Acetone | 5.62 |
| *1-11 | 0.15 | 0.15 | 0.4 | 0.45 | Acetone | 5.65 |
| *1-12 | 0.15 | 0.15 | 1.2 | 2.3 | Acetone | 5.60 |
| 1-13 | 0.15 | 0.15 | 0.4 | 0.45 | Propanol | 5.60 |

Samples marked with * are outside the scope of the present invention.

TABLE 1-2

| | | Average grain size | | | Material properties | | Wear resistance | Breakage |
|---|---|---|---|---|---|---|---|---|
| | η phase | | η | Number of η | Vickers | Bending | Hole position | resistance |
| Sample | ratio | WC | phase | phase of 1 μm | hardness | strength | accuracy X + 3σ | Maximum feed |
| No. | I₁/I₂ | (μm) | (μm) | or more | (GPa) | (MPa) | (μm) | speed (m/min) |
| 1-1 | 0.01 | 0.15 | 0.1 | 0 | 20.61 | 4750 | 18 | 7.8 |
| 1-2 | 0.01 | 0.2 | 0.15 | 0 | 20.51 | 4600 | 20 | 8.2 |
| 1-3 | 0.01 | 0.25 | 0.2 | 0 | 20.1 | 4580 | 26 | 7.6 |
| 1-4 | 0.01 | 0.3 | 0.25 | 1 | 19.89 | 4510 | 30 | 7.5 |
| *1-5 | 0.01 | 0.6 | 0.4 | 3 | 18.67 | 4450 | 75 | 7.2 |
| *1-6 | 0.08 | 0.2 | 0.15 | 0 | 20.81 | 3670 | 19 | 2.1 |
| 1-7 | 0.05 | 0.2 | 0.15 | 0 | 20.71 | 4120 | 21 | 6.2 |
| 1-8 | 0.04 | 0.2 | 0.1 | 0 | 20.65 | 4210 | 22 | 6.4 |
| 1-9 | 0.02 | 0.22 | 0.1 | 0 | 20.6 | 4360 | 16 | 6.5 |
| 1-10 | 0.005 | 0.23 | 0.1 | 0 | 20.4 | 4620 | 22 | 8.3 |
| *1-11 | 0 | 0.25 | — | 0 | 19.8 | 3930 | 58 | 2.2 |
| *1-12 | 0.01 | 0.2 | 0.22 | 2 | 20.51 | 3820 | 19 | 2.1 |
| 1-13 | 0.01 | 0.2 | 0.18 | 1 | 20.61 | 3980 | 18 | 3.5 |

Samples marked with * are outside the scope of the present invention.

According to Tables 1-1 and 1-2, the WC raw material of Sample No. 1-5 has a large particle size, and accordingly the average grain sizes of WC and η phase were increased. Consequently, the Vickers hardness was low and the wear resistance was poor. In Sample No. 1-6, the total carbon content was low, and accordingly the η phase ratio (I₁/I₂) is increase to 0.08, and the η phases become excessive. Consequently, the bending strength was low, and the breakage resistance was poor. In Sample No. 1-11, the amount of carbon added was high, and accordingly the η phase is not present. However, free carbon was precipitated because of the excessive carbon content. Consequently, the Vickers hardness and the bending strength were low, and the wear resistance and the breakage resistance were poor. In Sample No. 1-12, the average grain size of the η phase grains was larger than the average grain size of the WC grains. Consequently, the bending strength was low, and the breakage resistance was poor.

On the other hand, the samples according to the present invention exhibited Vickers hardnesses of 19.8 GPa or more, bending strengths of 3980 MPa or more, hole position accuracies of 30 μm or less, which represent wear resistance, and maximum feed speeds of 3.5 m/min, which represent breakage resistance, thus showing good properties.

### Example 2

A water-soluble tungsten raw material (ammonium tungstate), cobalt raw material (cobalt nitrate), V raw material (ammonium vanadate) and Cr raw material (chromium acetate) were dissolved in water in a proportion of 100 g of mixed raw material to 500 mL of water, and the solution was dried by spray-drying. Then, 100 g of the resulting spray-dried powder was thermally decomposed at 500° C. in a nitrogen atmosphere to yield WO₃—CoO—V₂O₅—Cr₃O₃ complex oxide powder.

The complex oxide powder was carbonized at a temperature of 800° C. in a CO/H₂ atmosphere to yield a complex carbide powder. The complex carbide powders were as follows: Sample Nos. 2-1 to 2-3 and 2-6 contained 91.2% by mass of WC, 8% by mass of Co, 0.3% by mass of VC, and 0.5% by mass of Cr₃C₂; Sample No. 2-4 contained 91% by mass of WC, 8% by mass of Co, 0.5% by mass of VC, and 0.5% by mass of Cr₃C₂; and Sample No. 2-5 contained 90% by mass of WC, 8% by mass of Co, 1.5% by mass of VC, and 0.5% by mass of Cr₃C₂.

Then, an organic solvent containing carbon slurry and propanol was added to the complex carbide powder, and wet mixing was performed for 72 hours in a ball mill.

Sample No. 2-7 was prepared by adding CoO powder, VC powder, and Cr₃C₂ powder to WC powder, and the composition contained 91.2% by mass of WC, 8% by mass of Co, 0.3% by mass of VC, and 0.5% by mass of Cr₃C₂.

After addition of a paraffin wax, the raw material slurry mixed in the ball mill was granulated and dried by spray-drying. After press forming, the material was fired in a vacuum, and then subjected to hot isostatic pressing (HIP) firing to yield a cemented carbide. The temperature was increased at a rate of 5° C./min before vacuum firing, and the vacuum firing was performed with a temperature profile in which a firing temperature of 900 to 1100° C. shown in Table 2-1 was held for 1 hour (first step) and then 1350° C. was held for 1 hour (second step). Subsequently, hot isostatic pressing firing was performed under the conditions of a temperature of 1340° C. and a pressure of 6 MPa in argon gas.

Whether or not carbon grains were present in the WC grains of the resulting cemented carbide was checked using a photograph of an arbitrary section of the sintered compact taken through a transmission electron microscope (TEM) at a magnification of 500 thousand times. The grain sizes of carbon grains present in 5 photographs (120×100 nm) of a magnification of 500 thousand times were each measured, and the average was calculated by division by the number of carbon grains. The resulting average grain size is shown in Table 2-2. The grain size of the carbon grains was defined by the maximum width of the carbon grains in the photograph.

For calculating the average grain size of the WC grains, the area occupied by the WC gains was calculated with image analysis software (ImagePro Plus produced by Nippon Roper) using a photograph taken through a scanning electron microscope (SEM) at a magnification of 30000 times, and was averaged. The average area was converted to the diameter of a sphere to obtain the average grain size, assuming that the WC grain was spherical. The results are shown in Table 2-1.

Furthermore, whether or not the outer portion of the carbon grain continued to the lattice planes of the WC grain was visually observed using a photograph taken through a transmission electron microscope (TEM) at a magnification of a million times. The results are shown in Table 2-2.

The resulting sintered compact was worked to a small thickness, and the oxygen content in the bonding phase was evaluated by measuring with a transmission electron microscope (TEM) and an energy dispersive spectrometer. The results are shown in Table 2-2.

Moreover, the bending strength was evaluated by bending the sample at three points at intervals of 20 mm. The sample was formed into a columnar shape having a diameter of 2 mm and a length of 30 mm. The Vickers hardness was obtained at a load of 9.8 N.

TABLE 2-1

| | Particle size of | Particle size | | | |
|---|---|---|---|---|---|
| | WC in raw | of Co in raw | First-step firing | Second-step | HIP firing |
| Sample | material | material | temperature | firing temperature | temperature |
| No. | nm | nm | ° C. | ° C. | ° C. |
| 2-1 | 150 | 20 | 1100 | 1350 | 1340 |
| 2-2 | 150 | 20 | 1000 | 1350 | 1340 |
| 2-3 | 150 | 20 | 900 | 1350 | 1340 |
| 2-4 | 150 | 20 | 1100 | 1350 | 1340 |
| 2-5 | 150 | 20 | 1100 | 1350 | 1340 |
| 2-6 | 120 | 30 | 950 | 1350 | 1340 |
| *2-7 | 600 | 500 | 1000 | 1350 | 1340 |

Samples marked with * are outside the scope of the present invention.

TABLE 2-2

| | | | Whether lattice | | | | | |
|---|---|---|---|---|---|---|---|---|
| | | | planes of outer | | | | | |
| | Whether | Average | portion of | Average | Oxygen | | | |
| | carbon | grain size | carbon grain | grain size | content in | Content of V | | |
| | grain is | of carbon | continues to | of WC | bonding | dissolved in | Vickers | Bending |
| Sample | present in | grain | lattice planes | grains | phase | WC | hardness | strength |
| No. | WC grain | nm | of WC grain | nm | mass % | mass % | GPa | GPa |
| 2-1 | Yes | 40 | Yes | 230 | 0.6 | 0.6 | 22 | 5.4 |
| 2-2 | Yes | 35 | Yes | 210 | 1.6 | 0.4 | 22.2 | 5.2 |
| 2-3 | Yes | 23 | Yes | 210 | 3 | 0.3 | 22.5 | 5.1 |
| 2-4 | Yes | 46 | Yes | 190 | 0.7 | 0.6 | 22.1 | 5.2 |
| 2-5 | Yes | 50 | Yes | 180 | 1.4 | 0.6 | 21.5 | 4.6 |
| 2-6 | Yes | 31 | Yes | 160 | 2.5 | 0.3 | 22.3 | 5 |
| *2-7 | No | — | — | 650 | 2.5 | 0.5 | 19.5 | 4.6 |

Samples marked with * are outside the scope of the present invention.

According to Tables 2-1 and 2-2, in Sample Nos. 2-1 to 2-6 according to the present invention, the average grain size of the carbon grains was 50 nm or less, the outer portion of the carbon grain had lattice planes continuing to the lattice planes of the WC grain, and the hardness was as high as 21.5 GPa or more. In Sample Nos. 2-1 to 2-6 of the present invention, in addition, the oxygen content in the bonding phase is as low as 3% by mass or less, and the bending strength was high. In Comparative Example No. 2-7, on the other hand, carbon grains were not formed, and the hardness was low.

The cemented carbide of Sample No. 2-3 according to the present invention was worked into a drill, and holes were formed in a substrate prepared by stacking three Hitachi 679FG's (Rotational speed of the drill: 300 krpm, feed speed: 10 m/min). As a result, problems with working did not occur even though holes were formed 20000 times.

In Sample Nos. 2-1 to 2-6, the ratio I₁/I₂ of the maximum peak intensity I₁ of peaks of Co₃W₃C, Co₆W₆C, Co₂W₄C and Co₃W₉C to the maximum peak intensity I₂ of WC peaks was 0.02 to 0.04 according to X-ray diffraction using Cukα ray; the average grain size of the WC grains was 0.16 to 0.23 μm, and the average grain size of cobalt tungsten carbide grains was 0.10 to 0.15 μm. Also, the number of η phases of 1 μm or more was zero.

Furthermore, the wear resistance and the breakage resistance were evaluated under the following conditions by working the tip of each sample to form a drill having a diameter of 0.120 mm and a length of 2.0 mm. For the wear resistance, the hole position accuracy was used as the index for the evaluation. For the hole position accuracy, X+3σ of the formation of 4000 holes was used as the index, and the feed speed in the thickness direction was set at 3 m/min. For the breakage resistance, the maximum feed speed was used as the index for the evaluation. The maximum feed speed refers to the maximum of feed speeds at which the drill is broken when the feed speed in the thickness direction is gradually increased for each hole. As a result, in Sample Nos. 2-1 to 2-6, the hole position accuracy was 15 to 30 μm, and the maximum feed speed was 5 m/min or more. The working conditions were as follows:

Rotational speed of the drill: 300 krpm

Feed speed: 2 to 20 m/min

Substrate used for evaluation: multilayer substrate including a stack of Hitachi 679G (0.4 mm, three sheets) having an entry sheet (LE800, 1 sheet) thereon.

### Example 3

A water-soluble tungsten raw material (ammonium tungstate), cobalt raw material (cobalt nitrate) and V raw material (ammonium vanadate) were dissolved in water in a proportion of 100 g of mixed raw material to 500 mL of water, and the solution was dried by spray-drying to yield a spray-dried powder. Then, 100 g of the resulting spray-dried powder was thermally decomposed at 500° C. in a nitrogen atmosphere to yield WO₃—CoO—V₂O₅ complex oxide powder.

The resulting WO₃—CoO—V₂O₅ complex oxide powder was carbonized to yield a complex carbide powder. C slurry for controlling the C content and Cr₃C₂ powder were weighed out and added to the complex carbide powder. An organic solvent comprising propanol was added, and the materials were mixed in a wet process for 72 hours in a ball mill.

After addition of a paraffin wax, the raw material slurry mixed in the ball mill was granulated and dried by spray-drying. After press forming, the material was fired in a vacuum, and subjected to hot isostatic pressing (HIP) to yield a cemented carbide shown in Table 3-1. For vacuum firing, the temperature was increased at a rate of 5° C./min and then held at 950° C. for 1 to 6 hours, and firing was performed at 1350° C. for 1 hour. The hot isostatic pressing was performed under the conditions of a temperature of 1340° C. and a pressure of 6 MPa in argon gas.

After polishing the surface of the resulting cemented carbide, the size of the section and the aspect ratio of the WC grain in an arbitrary section of the cemented carbide were evaluated using a photograph taken through a scanning electron microscope (SEM) at a magnification of 30000 times. Evaluation was performed such that tetragonal sections having an aspect ratio of 2 or more of the tetragonal sections exposed at an arbitrary section of a sintered compact in two SEM photographs taken at a magnification of 30000 times was traced, and the long side (length) and the short side (width) of the section were measured and averaged. The resulting average length and width are shown in Table 3-1.

The areas of all the sections having an aspect ratio of 2 or more were obtained by the long side length×the short side length, and the ratio of the total area of the sections having an aspect ratio of 2 or more to the area of the sections in the two photographs. Thus, the area ratio of the sections having an aspect ratio of 2 or more was obtained. The long side length (length) and the short side length (width) were the longer long side and the longer short side.

Whether the WC grains have a sheet-like shape or a columnar shape was checked by micromachining with an FIB apparatus. As a result, it was confirmed that the WC grains each had a height (length of the side surfaces) larger than the sides of the triangular bottom, and that the WC grains of the samples of the present invention were columnar.

In addition, the fracture toughness was evaluated at a load of 9.8 N, the bending strength was evaluated by bending the sample at three points at intervals of 20 mm. The results are shown in Table 3-1. The sample had a columnar shape having a diameter of 2 mm and a length of 30 mm. A bending strength of less than 4.0 Gpa was determined to be poor, a bending strength of 4 to 5 Gpa was determined to be fair, and a bending strength of more than 5 Gpa was determined to be good. The results are shown in Table 3-1.

TABLE 3-1

| | | Sintered compact composition | | | | Sintered | | | | |
|---|---|---|---|---|---|---|---|---|---|---|
| | Firing | (mass %) | | | | compact texture | | | Property | |
| | condition | V | V | Cr | Cr | Average | Average | Area | Facture | |
| Sample | 950° C. | VC | Addition | Cr₃C₂ | Addition | length | width | ratio | toughness | Bending |
| No. | holding time | basis | timing | basis | timing | (μm) | (μm) | (%) | (MPa · m^{1/2}) | strength |
| 3-1 | 1 | 0.025 | A | 0.6 | B | 0.54 | 0.21 | 14 | 9.5 | Good |
| 3-2 | 1 | 0.075 | A | 0.6 | B | 0.48 | 0.16 | 25 | 9.1 | Good |
| 3-3 | 1 | 0.6 | A | 0.6 | B | 0.37 | 0.12 | 30 | 8.9 | Good |
| 3-4 | 1 | 1 | A | 0.6 | B | 0.34 | 0.11 | 33.2 | 8.8 | Fair |

A: added in synthesis of complex oxide
B: added to complex carbide powder Average length, average width: averages of lengths and widths of sections having an aspect ratio of 2 or more of the tetragonal sections of WC grains in an arbitrary section.
Area ratio: ratio of the areas of sections having an aspect ratio of 2 or more to the tetragonal sections of WC grains.

The results shown in Table 3-1 suggest that by adding 0.025% to 1% by mass of V in terms of VC in the synthesis of the complex oxide and holding 950° C. for 1 hour, the WC grains can have a columnar shape, the area ratio of sections having an aspect ratio of 2 or more can be 10% or more, the fracture toughness can be 8.8 MPa·m^{1/2} or more, and thus the toughness can be enhanced.

The results also show that by controlling the area ratio of the sections having an aspect ratio of 2 or more to 30% or less, the bending strength can be enhanced.

In Sample Nos. 3-1 to 3-4, the ratio I₁/I₂ of the maximum peak intensity I₁ of peaks of Co₃W₃C, Co₆W₆C, Co₂W₄C and Co₃W₉C to the maximum peak intensity I₂ of WC peaks was 0.02 to 0.04 according to X-ray diffraction using Cukα ray; the average grain size of the WC grains was 0.15 to 0.20 μm; and the average grain size of cobalt tungsten carbide grains was 0.10 to 0.15 μm. Also, the number of η phases of 1 μm or more was zero, and the Vickers hardness was 20 GPa or more.

Furthermore, the wear resistance and the breakage resistance were evaluated under the following conditions by working the tips of Sample Nos. 3-1 to 3-4 to form drills having a diameter of 0.120 mm and a length of 2.0 mm. For the wear resistance, the hole position accuracy was used as the index for the evaluation. For the hole position accuracy, X+3σ of the formation of 4000 holes was used as the index, and the feed speed in the thickness direction was set at 3 m/min. For the breakage resistance, the maximum feed speed was used as the index for the evaluation. The maximum feed speed refers to the maximum of feed speeds at which the drill is broken when the feed speed in the thickness direction is gradually increased for each hole. As a result, in Sample Nos. 3-1 to 3-4, the hole position accuracy was 15 to 30 μm, and the maximum feed speed was 5 m/min or more. The working conditions were as follows:

Rotational speed of the drill: 300 krpm

Feed speed: 2 to 20 m/min

Substrate used for evaluation: multilayer substrate including a stack of Hitachi 679G (0.4 mm, three sheets) having an entry sheet (LE800, 1 sheet) thereon.

1. A cemented carbide, comprising:
a hard phase comprising WC grains having an average grain size of 0.3 μm or less;
a bonding phase comprising Co; and
cobalt tungsten carbide grains having an average grain size smaller than that of the WC grains,
wherein 0<I₁/I₂≦0.05 is satisfied, where I₁ represents the maximum peak intensity of X-ray diffraction peak of the cobalt tungsten carbide, and I₂ represents the maximum peak intensity of the WC.

2. The cemented carbide according to claim 1, wherein
the number of cobalt tungsten carbide grains having a grain size of 1 μm or more is one or zero in a field of view of 40 μm square of an electron micrograph of a section of the cemented carbide taken at a magnification of 30000 times.

3. (canceled)

4. The cemented carbide according claim 16, wherein
the carbon grain has an average grain size of 50 nm or less.

5. The cemented carbide according claim 16, wherein
the bonding phase contains 3% by mass or less of oxygen.

6. The cemented carbide according to claim 1, wherein
the WC grains comprise columnar grains,
a plurality of tetragonal sections of the WC grains are exposed at an arbitrary section of the cemented carbide, and
the tetragonal sections of the WC grains having an aspect ratio of 2 or more account for 10% or more of all the tetragonal sections of the WC grains on an area basis.

7. The cemented carbide according to claim 6, wherein
the tetragonal sections of the WC grains having an aspect ratio of 2 or more each have a long side and the average length of the long sides is 1 μm or less.

8. The cemented carbide according to claim 6, wherein
the tetragonal sections of the WC grains having an aspect ratio of 2 or more account for 30% or less of all the tetragonal sections of the WC grains on an area basis.

9. A cutting tool comprising the cemented carbide according to claim 1.

10. A cutting apparatus comprising:
the cutting tool according to claim 9; and
a support configured to support a material to be cut with the cutting tool.

11. The cemented carbide according to claim 1, wherein the cobalt tungsten carbide comprises Co₃W₃C, Co₆W₆C, Co₂W₄C, or Co₃W₉C.

12. The cemented carbide according to claim 11, wherein the cobalt tungsten carbide consists of at least one selected from the group consisting of Co₃W₃C, Co₆W₆C, Co₂W₄C, and Co₃ W₉C.

13. The cemented carbide according to claim 1, wherein 0.005≦I₁/I₂≦0.03 is satisfied.

14. The cemented carbide according to claim 1, wherein
the cemented carbide comprises 0.1 to 1.5 mass % of Vanadium in terms of VC and 0.1 to 2.5 mass % of Chromium in terms of Cr₃C₂ in total weight thereof.

15. The cemented carbide according to claim 1, wherein
the WC grains have an average grain size of 0.1 μm or more.

16. A cemented carbide, comprising
WC grains, one or more of the WC grains each comprising a carbon grain therein, wherein the outer portion of the carbon grain has lattice planes continuing to the lattice planes of the WC grain;
a bonding phase comprising Co; and
cobalt tungsten carbide grains.

17. A drill, comprising the cemented carbide according to claim 1, and further comprising a shank portion and a cutting edge having a circular section and a diameter of 300 μm or less.

18. The drill according to claim 17, wherein
the cutting edge has a length of 1 mm or more.
